(19) United States
(12) Patent Application Publication
(10) Pub. No.: US 2017/0045768 A1
(43) Pub. Date: Feb. 16, 2017

(54) LIQUID CRYSTAL DISPLAY PANEL AND METHOD OF FABRICATING THE SAME

(71) Applicant: Himax Display, Inc., Tainan City (TW)

(72) Inventors: Chia-Yeh Tsai, Tainan City (TW); Hsing-Lung Wang, Tainan City (TW); Kuan-Hsu Fan Chiang, Tainan City (TW); Hsien-Chang Tsai, Tainan City (TW)

(21) Appl. No.: 14/823,407

(22) Filed: Aug. 11, 2015

(51) Int. Cl. G02F 1/1368; G02F 1/1337; C09J 9/02; G02F 1/1339

(52) U.S. Cl. CPC G02F 1/1368; G02F 1/1339; G02F 1/1337; C09J 9/02

(57) ABSTRACT

Provided is a method of fabricating a liquid crystal display panel. An active device array substrate and an opposite substrate are provided, wherein the active device array substrate includes a first substrate and a first electrode layer, and the opposite substrate includes a second substrate and a second electrode layer. A first alignment film is formed on the first electrode layer and a second alignment film is formed on the second electrode layer. A sealant composition including an adhesive and conductive particles is applied on one of the first alignment film and the second alignment film. The active device array substrate and the opposite substrate are assembled, wherein the assembling step includes heating the sealant composition so as to merge a part of the conductive particles into a conductive material piercing through the first alignment film and the second alignment film, respectively.

### BACKGROUND

Field of Invention

The present disclosure relates to display technologies, and more particularly, to a liquid crystal display panel and a method of fabricating the same.

Description of Related Art

The basic structure of a liquid crystal display includes an active device array substrate, an opposite substrate, a sealant connecting the active device array substrate and the opposite substrate, and a liquid crystal material filled into a space defined by the active device array substrate, the opposite substrate, and the sealant. In addition, to better control the alignment of liquid crystal molecules, an alignment film is deposited in advance on each of the active device array substrate and the opposite substrate. The alignment film is generally made of a polymer material such as polyimide (PI), which is a non-conductive material. In consequence, the presence of alignment films introduces some complexities to the electrical communication between the active device array substrate and the opposite substrate.

### SUMMARY

The present disclosure provides a method of fabricating a liquid crystal display panel including the following steps. An active device array substrate and an opposite substrate are provided, wherein the active device array substrate includes a first substrate and a first electrode layer disposed on the first substrate, and the opposite substrate includes a second substrate and a second electrode layer disposed on the second substrate. A first alignment film is formed on the first electrode layer and a second alignment film is formed on the second electrode layer. A sealant composition is applied on one of the first alignment film and the second alignment film, wherein the sealant composition includes an adhesive and a plurality of conductive particles dispersed in the adhesive. The active device array substrate and the opposite substrate are assembled, wherein assembling the active device array substrate and the opposite substrate includes heating the sealant composition so as to merge a part of the conductive particles into a conductive material piercing through the first alignment film and the second alignment film, respectively.

In an embodiment, the conductive material contacts with the first electrode layer and the second electrode layer, respectively.

In an embodiment, the conductive particles include nickel.

In an embodiment, the diameter of the conductive particles is smaller than 1 μm.

In an embodiment, the diameter of the conductive particles ranges from 10 nm to 500 nm.

In an embodiment, the sealant composition includes 1 wt % to 15 wt % of the conductive particles.

In an embodiment, the sealant composition includes 1 wt % to 5 wt % of the conductive particles.

The present disclosure further provides a liquid crystal display panel, including an active device array substrate, an opposite substrate, a first alignment film, a second alignment film, and a sealant. The active device array substrate includes a first substrate and a first electrode layer disposed on the first substrate. The opposite substrate includes a second substrate and a second electrode layer disposed on the second substrate. The first alignment film is disposed on the first electrode layer. The second alignment film is disposed on the second electrode layer. The sealant is disposed between the active device array substrate and the opposite substrate. The sealant includes an adhesive and a conductive material in the adhesive, wherein the conductive material pierces through the first alignment film and the second alignment film, respectively.

In an embodiment, the conductive material includes nickel.

### BRIEF DESCRIPTION OF THE DRAWINGS

The present disclosure can be more fully understood by reading the following detailed description of the embodiment, with reference made to the accompanying drawings as follows:

FIG. 1 is a process flow of a method of fabricating a liquid crystal display panel according to an embodiment of the present disclosure;

FIG. 2 is a schematic top view showing an intermediate stage of a method of fabricating a liquid crystal display panel according to an embodiment of the present disclosure;

FIG. 3 is a schematic cross-sectional view showing an intermediate stage of a method of fabricating a liquid crystal display panel according to an embodiment of the present disclosure; and

FIG. 4 is a schematic cross-sectional view showing an intermediate stage of a method of fabricating a liquid crystal display panel according to an embodiment of the present disclosure.

### DETAILED DESCRIPTION

In the following description, directional or positional relation indicated by terms such as “at the center of,” “on,” “over,” “under,” “below,” “in front of,” “behind,” “at the left of,” and “at the right of” is the directional or positional relation with reference to the figures. These terms are used to simplify the description, and using these terms does not indicate or suggest a specific configuration or orientation for operation of the device or element being described. In addition, terms such as “first” and “second” are used for descriptive purpose and shall not be construed as indicating or suggesting an element is more significant than another. Unless otherwise specified, terms such as “disposed,” “attached,” and “connected” shall be construed in their broad sense. For example, “connected” includes “fixedly connected,” “detachably connected,” or “integrally connected”; it also includes “mechanically connected” or “electrically connected”; it further includes “directly connected” or “connected via an intermediate element.” The meaning of these terms in the present disclosure shall be construed in light of the specific context. In addition, unless otherwise specified, in the following description, “a plurality of” or “several” means “two or more than two.”

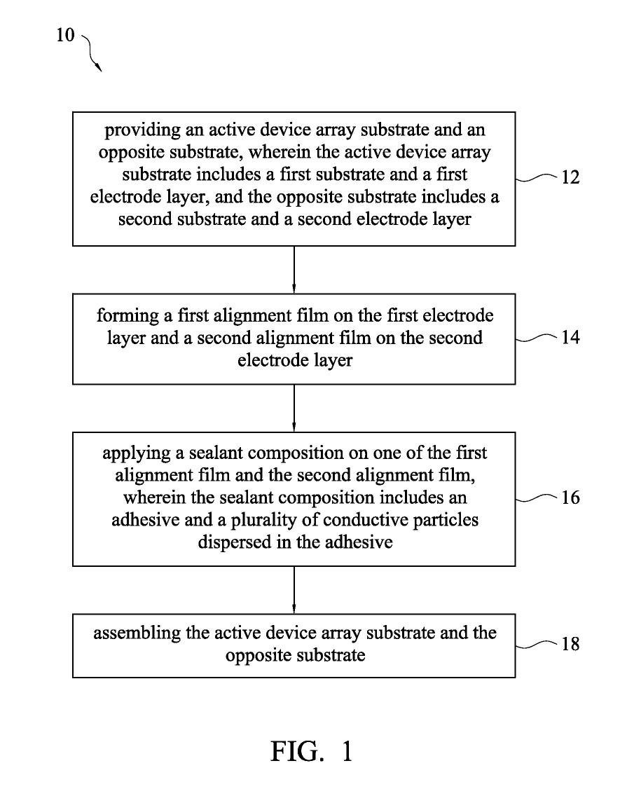

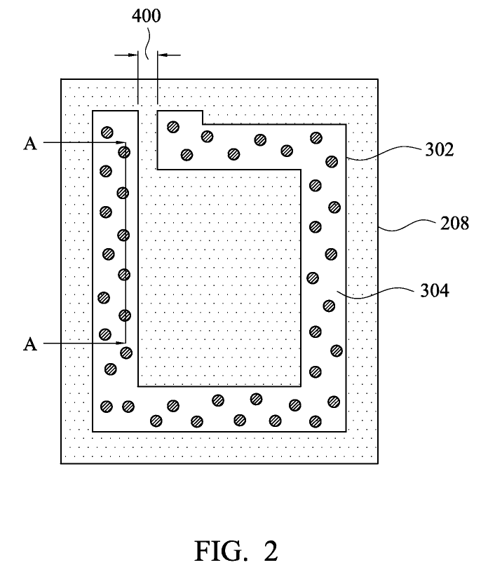

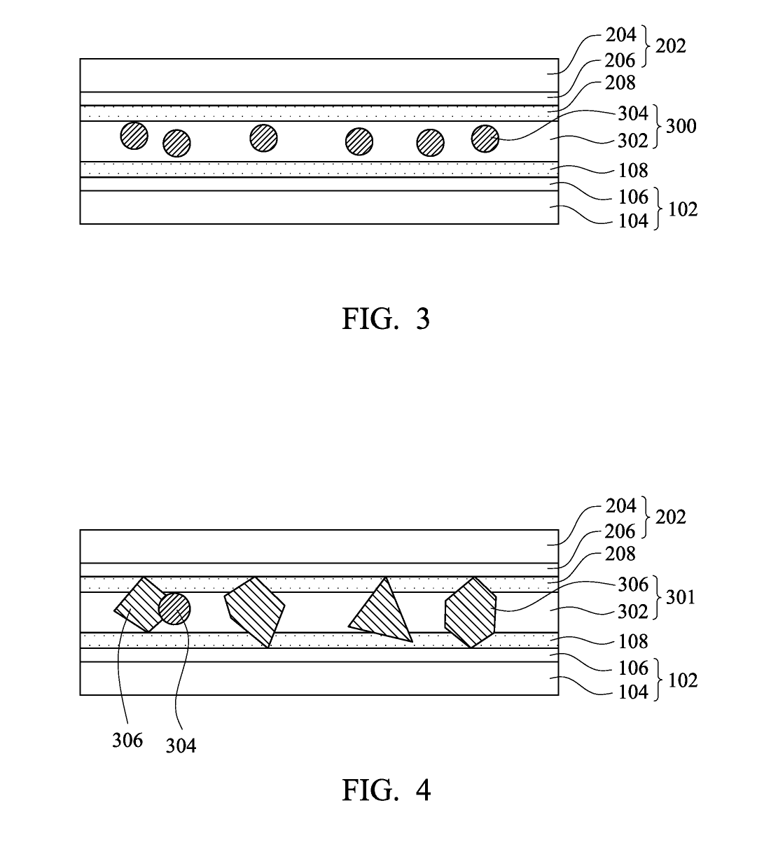

FIG. 1 is a process flow of a method of fabricating a liquid crystal display panel according to an embodiment of the present disclosure. The steps shown in FIG. 1 will be discussed in detail with reference to FIG. 2 to FIG. 4 in the following paragraphs. FIG. 2 is a schematic top view showing an intermediate stage of a method of fabricating a liquid crystal display panel according to an embodiment of the present disclosure. FIG. 3 is a schematic cross-sectional view showing an intermediate stage of a method of fabricating a liquid crystal display panel according to an embodiment of the present disclosure.

Referring to FIG. 1 and FIG. 3, the method 10 of fabricating a liquid crystal display panel includes steps 12, 14, 16, and 18. In the step 12, an active device array substrate 102 and an opposite substrate 202 are provided. The active device array substrate 102 includes a first substrate 104 and a first electrode layer 106 disposed on the first substrate 104. The opposite substrate 202 includes a second substrate 204 and a second electrode layer 206 disposed on the second substrate 204.

The first substrate 104 may be a silicon wafer in which a plurality of active devices (not shown in the figures) are formed and arranged in array. The active devices may be metal-oxide-semiconductor field effect transistors (MOSFETs) or other active devices. The first electrode layer 106 may be a pixel electrode layer and may be made of, for example, aluminum (Al). In other embodiments, the first substrate 104 may be a transparent substrate (a glass substrate for example), and active devices such as thin film transistors (TFTs, not shown in the figures) may be formed in the first substrate 104.

The second substrate 204 may be a transparent substrate such as a glass substrate. The second electrode layer 206 may be a common electrode layer and may be made of a transparent conductive material such as indium tin oxide (ITO). The opposite substrate 202 may be a color filter substrate and thus may further include a black matrix (not shown in the figures) that defines a plurality of display areas and color filter layers (not shown in the figures) disposed in the display areas. It is noted that, materials, structures, and fabrication methods of the active devices, the color filters, and the black matrix are well understood in the relevant technical field and therefore those details are omitted herein for a concise description.

Still referring to FIG. 1 and FIG. 3, in the step 14, a first alignment film 108 is formed on the first electrode layer 106 and a second alignment film 208 is formed on the second electrode layer 206. The first alignment film 108 and the second alignment film 208 may be formed by applying a polymer layer onto each of the first electrode layer 106 and the second electrode layer 206, and then curing the polymer layers with a temperature between, for example, 100° C. and 180° C. The aforementioned polymer includes, for example, polyimide (PI), and may be applied to the electrode layers by any existing coating techniques. After the coating and the curing processes, the alignment films 108 and 208 may be rubbed to obtain a predetermined alignment direction.

Referring to FIG. 1, FIG. 2, and FIG. 3, in the step 16, a sealant composition 300 is applied on the second alignment film 208. In other embodiment, it is also possible to apply the sealant composition 300 on the first alignment film 108. It is noted that, after the sealant composition 300 is applied, a gap 400 (shown in FIG. 2) is remained for the subsequent placement of a liquid crystal material between the active device array substrate 102 and the opposite substrate 202. The sealant composition 300 includes an adhesive 302 and a plurality of conductive particles 304 dispersed in the adhesive 302. The adhesive 302 may be a heat-curable adhesive. The conductive particles 304 may be selected so that as being heated subsequently, a part of the conductive particles 304 merges to form a bulk conductive material (see FIG. 4 and the following description). In this regards, the conductive particles 304 may include nickel.

FIG. 4 is a schematic cross-sectional view showing a stage following that shown in FIG. 3. Please note that FIG. 3 and FIG. 4 are, respectively, cross-sections taken along the direction AA in FIG. 2 after the positioning step and the heating step described later. Referring to FIG. 1, FIG. 3, and FIG. 4, in the step 18, the active device array substrate 102 and the opposite substrate 202 are assembled. The assembling process includes, first, positioning the active device array substrate 102 adjacent to the opposite substrate 202, so that the active device array substrate 102 is separated from the opposite substrate 202 by a plurality of spacers (not shown in the figures) so as to form a cell gap. Then, the assembling process further includes heating the sealant composition 300 so as to cure the adhesive 302 and to merge a part of the conductive particles 304 into a conductive material 306. It is noted that the conductive material 306 would naturally pierces through the first alignment film 108 and the second alignment film 208, respectively. It is also shown in FIG. 4 that the conductive material 306 contacts respectively with the first electrode layer 106 and the second electrode layer 206, so as to enable electrical communication between the active device array substrate 102 and the opposite substrate 202. The conventional way to achieve the very same purpose is to etch the alignment films to expose the electrode layers, and then to form an electrical connection between the electrode layers. The method described here thus eliminates the patterning step. Thereafter, a liquid crystal material may be filled into the space defined by the active device array substrate 102, the opposite substrate 202, and the sealant 301.

Since the conductive material 306 is formed by merging a part of the conductive particles 304, the dimension of the conductive material 306 is influenced by the diameter of the conductive particles 304 as well as the relative amount of the conductive particles 304 to the adhesive. For example, if the diameter of the conductive particles 304 is too large, or the ratio of the conductive particles 304 to the adhesive 302 is too high, the dimension of the resulting conductive material 306 may exceed the predetermined cell gap, leading to a non-uniform cell gap. In this regards, the diameter of the conductive particles may be smaller than 1 μm, and for example, may range from 10 nm to 500 nm. Meanwhile, the sealant composition 300 may include 1 wt % to 15 wt % (in some instances 1 wt % to 5 wt %) of the conductive particles 304.

Another embodiment of the present disclosure provides a liquid crystal display panel, which will be described with reference to FIG. 4. The liquid crystal display panel of the present disclosure includes an active device array substrate 102, an opposite substrate 202, a first alignment film 108, a second alignment film 208, and a sealant 301. The active device array substrate 102 includes a first substrate 104 and a first electrode layer 106 disposed on the first substrate 104. The opposite substrate 202 includes a second substrate 204 and a second electrode layer 206 disposed on the second substrate 204. The first alignment film 108 is disposed on the first electrode layer 106. The second alignment film 208 is disposed on the second electrode layer 206. The sealant 301 is disposed between the active device array substrate 102 and the opposite substrate 202. The sealant 301 includes an adhesive 302 and a conductive material 306 in the adhesive 302, wherein the conductive material 306 pierces through the first alignment film 108 and the second alignment film 208, respectively. The first substrate 104, the first electrode layer 106, the first alignment film 108, the second substrate 204, the second electrode layer 206, the second alignment film 208, the adhesive 302, and the conductive material 306 may be the same as those described above. Repetitions are avoided for brevity.

Accordingly, the present disclosure provides a method of fabricating a liquid crystal display panel and a liquid crystal display panel fabricated by said method. By adopting this method, the process for achieving electrical communication between the active device array substrate and the opposite substrate is incorporated into the process of applying the sealant. Similarly, the additional electrical connection element that is necessary in conventional method is eliminated. Therefore, the method of the present disclosure simplifies the fabrication process of a liquid crystal display panel and provides the possibility to further reduce the dimension of the liquid crystal display panel.

Although the present disclosure has been described in detail, it should be understood that various changes, substitutions and alterations could be made herein without departing from the spirit and scope of the disclosure as defined by the appended claims. Moreover, the scope of the present disclosure is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or step.

1. A method of fabricating a liquid crystal display panel, comprising:
providing an active device array substrate and an opposite substrate, wherein the active device array substrate comprises a first substrate and a first electrode layer disposed on the first substrate, and the opposite substrate comprises a second substrate and a second electrode layer disposed on the second substrate;
forming a first alignment film on the first electrode layer and a second alignment film on the second electrode layer;
applying a sealant composition on one of the first alignment film and the second alignment film, wherein the sealant composition comprises an adhesive and a plurality of conductive particles dispersed in the adhesive; and
assembling the active device array substrate and the opposite substrate, wherein assembling the active device array substrate and the opposite substrate comprises:
curing the adhesive by subjecting the sealant composition to a heat; and
respectively merging a part of the conductive particles into a plurality of bulk conductive materials by the heat, wherein at least one of the bulk conductive materials pierces through the first alignment film and the second alignment film, and an other part of the conductive particles electrically connected to the bulk conductive materials.

2. The method of claim 1, wherein the conductive material contacts with the first electrode layer and the second electrode layer, respectively.

3. The method of claim 1, wherein the conductive particles comprise nickel.

4. The method of claim 1, wherein a diameter of the conductive particles is smaller than 1 μm.

5. The method of claim 1, wherein a diameter of the conductive particles ranges from 10 nm to 500 nm.

6. The method of claim 1, wherein the sealant composition comprises 1 wt % to 15 wt % of the conductive particles.

7. The method of claim 1, wherein the sealant composition comprises 1 wt % to 5 wt % of the conductive particles.

8. A liquid crystal display panel, comprising:
an active device array substrate, comprising a first substrate and a first electrode layer disposed on the first substrate;
an opposite substrate, comprising a second substrate and a second electrode layer disposed on the second substrate;
a first alignment film disposed on the first electrode layer;
a second alignment film disposed on the second electrode layer; and
a sealant disposed between the active device array substrate and the opposite substrate, the sealant comprising an adhesive and a plurality of bulk conductive materials and a plurality of conductive particles in the adhesive, wherein at least one of the bulk conductive materials directly pierces through the first alignment film and the second alignment film, and the conductive particles electrically connect to the bulk conductive materials.

9. The liquid crystal display panel of claim 8, wherein the conductive material contacts with the first electrode layer and the second electrode layer, respectively.

10. The liquid crystal display panel of claim 8, wherein the conductive material comprises nickel.
